(19) United States
(12) Patent Application Publication
(10) Pub. No.: US 2026/0159307 A1
(43) Pub. Date: Jun. 11, 2026

(54) SYSTEM AND METHOD FOR LINING A SUBSTRATE SURFACE SUBJECTABLE TO EROSION

(71) Applicants: SYNCRUDE CANADA LTD. IN TRUST FOR THE OWNERS OF THE SYNCRUDE PROJECT AS SUCH C, Calgary (CA); SILICON HOLDING BV., The Hague (NL)

(72) Inventors: Shane D. RYAN, Calgary (CA); Hugh ROTH, Calgary (CA); Jerome M. GAROT, The Hague (NL); Danielle F. GAROT, The Hague (NL)

(73) Assignees: SYNCRUDE CANADA LTD. IN TRUST FOR THE OWNERS OF THE SYNCRUDE PROJECT AS SUCH C, Calgary (CA); SILICON HOLDING BV., The Hague (NL)

(21) Appl. No.: 19/409,002

(22) Filed: Dec. 4, 2025

Related U.S. Application Data
(60) Provisional application No. 63/728,453, filed on Dec. 5, 2024.

(51) Int. Cl. B65D 90/04; F16B 5/08

(52) U.S. Cl. CPC B65D 90/043; F16B 5/08

(57) ABSTRACT

Systems and methods for lining a substrate surface subjectable to erosion are provided. The system includes a stud weldable tile including an erosion resistant plate and a stud configured to be welded to the substrate surface. The stud weldable tile can optionally include a breakaway pin operatively engageable with a stud welding gun. The breakaway pin can be detached from the erosion resistant plate after stud welding the stud weldable tile to the substrate surface. The erosion resistant plate can be made of a metal alloy. Alternatively, the stud weldable tile can include an anchor assembly including a stud and a plurality of anchor arms, and an erosion resistant plate being precast around the plurality of anchor arms, the erosion resistant plate being made for instance of a refractory material. The stud weldable tiles can also be used for repairing a lining previously installed on a substrate surface.

### CROSS REFERENCE

This application claims the benefit of, and priority to, U.S. provisional patent application 63/728,453 filed on Dec. 5, 2024, and entitled “SYSTEM AND METHOD FOR LINING A SUBSTRATE SURFACE SUBJECTABLE TO EROSION”, the content of which is hereby incorporated by reference in its entirety.

### TECHNICAL FIELD

The technical field generally relates to techniques for protecting surfaces. In particular, the technical field relates to techniques for protecting surfaces subjectable to erosion.

### BACKGROUND

Various industrial applications can cause erosion on surfaces, where the surface is subjected to high pressures and/or high temperatures. Examples of such surfaces can include internals of a reactor or equipment receiving process streams. The erosion of surfaces can lead to surface failure, which in turn can lead to equipment or process failures. Although conventional methods for protecting surfaces from erosion exist, such conventional methods typically require lengthy installation and replacement procedures that are unsuitable for industrial processes for which shorter facility downtime may be desired.

An example of such conventional methods can include the installation of a refractory lining onto the surface, where an anchoring assembly or a honeycomb steel mesh is installed onto the surface, and a refractory material is subsequently installed cured in situ. However, this conventional method has various drawbacks, including the lengthy installation of the refractory material onto the surface where the anchoring assembly is located or into respective hexagons of the honeycomb steel mesh, this installation being required to be performed in a confined space.

Furthermore, refractory linings can be damaged during normal processing conditions, and may subsequently require repair. Repair of a refractory lining is typically scheduled during facility downtime and can also be a lengthy process that undesirably extends a turnaround window, given the time required to apply once again the refractory material onto the refractory anchors of the anchoring assembly. Depending on the extent of damage to the refractory lining, the repairs can involve a trade off between complete repair of the refractory lining and extension of facility downtime.

Accordingly, there remains a number of challenges associated with the protection of surfaces subjectable to erosion.

### SUMMARY

In accordance with an implementation, a system for lining a substrate surface subjectable to erosion, the system comprising:
a stud weldable tile, comprising:
   an erosion resistant plate made of an erosion resistant plate material and having a top surface and a bottom surface opposite the top surface; and
   a stud extending outwardly from the bottom surface of the erosion resistant plate, the stud being made of a stud material and having a welding end configured to be welded to the substrate surface.

In some implementations, the erosion resistant plate and the stud form a monolithic structure.

In some implementations, the erosion resistant plate is mechanically engaged with the stud.

In some implementations, the erosion resistant plate material and the stud material are distinct materials.

In some implementations, the stud material comprises carbon steel or stainless steel.

In some implementations, the erosion resistant plate material comprises a metal alloy.

In some implementations, the system further comprises a compressible membrane provided underneath the erosion resistant plate and partially around the stud to at least partially fill a void defined between the bottom surface of the erosion resistant plate and the substrate surface once the stud weldable tile is welded to the substrate surface, the compressible membrane having a substrate surface engaging portion.

In some implementations, the compressible membrane is spaced apart from the welding end of the stud, thereby defining a ferrule-receiving cavity configured to receive a ferrule therein.

In some implementations, the system further comprises the ferrule surrounding the welding end of the stud and received within the ferrule-receiving cavity to contain mounting residue from the stud welding when the stud weldable tile is subjected to welding.

In some implementations, the compressible membrane is spaced apart from the welding end of the stud, thereby defining a molten metal-receiving cavity configured to receive molten metal therein.

In some implementations, the compressible membrane defines vents enabling weld gas generated during welding to be vented out from the compressible membrane when the stud weldable tile is subjected to welding, the compressible membrane being non-porous and configured to act as a ferrule.

In some implementations, the compressible membrane has a height that is taller in proximity of the stud compared to the height of the compressible membrane at an outer periphery thereof, such that the substrate surface engaging portion is an angled substrate surface engaging portion configured to follow a curvature of the substrate surface.

In some implementations, the stud extends outwardly past the compressible membrane.

In some implementations, the compressible membrane comprises a ceramic fiberboard material.

In some implementations, the compressible membrane comprises kaolin-based refractory fibers.

In some implementations, the system further comprises a breakaway pin extending outwardly from the top surface of the erosion resistant plate in a direction opposite to the stud and being operatively engageable with a stud welding gun, the breakaway pin being configured to be detached from the erosion resistant plate after stud welding the stud weldable tile.

In some implementations, the erosion resistant plate is curved away from the stud or toward the stud.

In some implementations, the welding end of the stud comprises a buttered overlay.

In some implementations, the erosion resistant plate is shaped as a polygon.

In some implementations, an adjacent erosion resistant plate configured for placement adjacent to the stud weldable tile is shaped as a complementary polygon.

In some implementations, the erosion resistant plate includes a curved edge.

In some implementations, the erosion resistant plate comprises a coating provided on a transversal surface of the erosion resistant plate to act as a barrier of an electric current between adjacent stud weldable tiles.

In accordance with another aspect, there is provided a system for lining a substrate surface subjectable to erosion, the system comprising:
a stud weldable tile, comprising:
   an anchor assembly made of an anchor assembly material, comprising:
      a stud having a welding end configured to be welded to the substrate surface; and
      a plurality of anchor arms extending outwardly from the stud in a common plane; and
   an erosion resistant plate precast around the plurality of anchor arms, the erosion resistant plate being made of an erosion resistant plate material and having a top surface and a bottom surface opposite the top surface.

In some implementations, the system further comprises a breakaway pin extending outwardly from the anchor assembly opposite to the stud and being operatively engageable with a stud welding gun, the breakaway pin being configured to be detached from the anchor assembly after stud welding the stud weldable tile.

In some implementations, the breakaway pin and the anchor assembly form a monolithic structure.

In some implementations, the erosion resistant plate material comprises a refractory material.

In some implementations, the refractory material comprises a ceramic.

In some implementations, the anchor assembly material comprises a metal alloy.

In some implementations, at least one anchor arm of the plurality of anchor arms comprises a tab extending outwardly from the at least one anchor arm to further anchor the erosion resistant plate.

In some implementations, the plurality of anchor arms is mechanically engaged with the stud.

In some implementations, the welding end of the stud comprises a buttered overlay.

In some implementations, the erosion resistant plate at least partially fills a void defined between the plurality of anchor arms and the substrate surface once the stud weldable tile is welded to the substrate surface, the erosion resistant plate having a substrate surface engaging portion.

In some implementations, the erosion resistant plate is spaced apart from the welding end of the stud, thereby defining a ferrule-receiving cavity configured to receive a ferrule therein.

In some implementations, the system further comprises the ferrule surrounding the welding end of the central stud and received within the ferrule-receiving cavity to contain mounting residue from the stud welding when the stud weldable tile is subjected to welding.

In some implementations, the erosion resistant plate is spaced apart from the welding end of the stud, thereby defining a molten metal-receiving cavity configured to receive molten metal therein.

In some implementations, the erosion resistant plate defines vents enabling weld gas generated during welding to be vented out from the erosion resistant plate when the stud weldable tile is subjected to welding, the erosion resistant plate being configured to act as a ferrule.

In some implementations, the erosion resistant plate has a height that is taller in proximity of the stud compared to the height of the erosion resistant plate at an outer periphery thereof, such that the substrate surface engaging portion is an angled substrate surface engaging portion configured to follow a curvature of the substrate surface.

In some implementations, the stud extends outwardly past the erosion resistant plate.

In some implementations, the erosion resistant plate is shaped as a polygon.

In some implementations, an adjacent erosion resistant plate configured for placement adjacent to the stud weldable tile is shaped as a complementary polygon.

In some implementations, the erosion resistant plate comprises a coating provided on a transversal surface of the erosion resistant plate to act as a barrier of an electric current between adjacent stud weldable tiles.

In accordance with another aspect, there is provided a method for lining a substrate surface subjectable to erosion, the method comprising:
stud welding a stud weldable tile as defined herein onto the substrate surface.

In some implementations, the method, further comprises:
stud welding at least one additional stud weldable tile as defined herein onto the substrate surface until a selected surface area of the substrate surface is covered by multiple stud weldable tiles.

In some implementations, the first stud weldable tile is shaped as a first polygon, and the at least one additional stud weldable tile is shaped as a complementary polygon relative to the first polygon.

In accordance with another aspect, there is provided a method for repairing a lining previously installed on a substrate surface, the method comprising:
stud welding a first stud weldable tile as defined herein onto a portion of the substrate surface stripped of a previously installed erosion lining.

In some implementations, the method further comprises stud welding at least one additional stud weldable tile as defined herein onto the portion of the substrate surface until the portion of the substrate surface is covered by multiple stud weldable tiles.

### BRIEF DESCRIPTION OF THE DRAWINGS

The attached figures illustrate various features, aspects and implementations of the technology described herein.

FIG. 1 is a front view of a stud weldable tile, in accordance with an implementation.

FIG. 2 is a front view of a stud weldable tile including a stud having a welding end covered by a buttered overlay.

FIG. 3 is a front view of a stud weldable tile including an erosion resistant plate mechanically engaged with a stud, in accordance with an implementation.

FIG. 4 is a front view of a stud weldable tile including an erosion resistant plate mechanically engaged with a stud, in accordance with another implementation.

FIG. 5 is a front view of a stud weldable tile including an erosion resistant plate, a ferrule engaged with a stud and an electrically insulating coating provided on transversal surfaces of the erosion resistant plate, in accordance with an implementation.

FIG. 6 is a front view of a stud weldable tile including an erosion resistant plate, a ferrule engaged with a stud and a compressible membrane provided underneath a bottom surface of the erosion resistant plate, in accordance with an implementation.

FIG. 7 is a front view of a stud weldable tile and a compressible membrane acting as a ferrule, in accordance with an implementation.

FIG. 8 is a front view of a stud weldable tile and a compressible membrane acting as a ferrule, in accordance with another implementation.

FIG. 9 is a front transparent view of a stud weldable tile including an anchor assembly and an erosion resistant plate, in accordance with an implementation.

FIG. 10 is a front transparent view of a stud weldable tile including an anchor assembly, an erosion resistant plate, and a ferrule engaged with a stud, in accordance with an implementation.

FIG. 11 is a top transparent view of the stud weldable tile of FIGS. 9 and 10.

FIG. 12A is a top view of a stud weldable tile having a hexagonal shape.

FIG. 12B is a top view of a stud weldable tile having a quadrilateral shape.

FIG. 12C is a top view of a stud weldable tile having a pentagonal shape.

FIG. 12D is a top view of a stud weldable tile having a quadrilateral shape.

FIG. 12E is a top view of a stud weldable tile having a triangular shape.

FIG. 12F is a top view of a stud weldable tile having a quadrilateral shape.

FIG. 12G is a top view of stud weldable tiles having complementary polygonal shapes, together forming a resulting hexagonal shape, in accordance with an implementation.

FIG. 13 is a top view of a lining including nine stud weldable tiles having a hexagonal shape and eleven stud weldable tiles having a complementary polygonal shape, in accordance with an implementation.

FIG. 14 is a cross-sectional view of a system lining a substrate surface having a curvature, in accordance with an implementation.

FIG. 15 is a front view of a stud weldable tile having an erosion resistant plate that is curved toward the stud.

FIG. 16 is a top view of a lining including twelve stud weldable tiles having complementary curved edges, in accordance with an implementation.

FIG. 17 is a front view of a stud weldable tile, in accordance with another implementation.

FIG. 18 is a front transparent view of a stud weldable tile including an anchor assembly and an erosion resistant plate, in accordance with another implementation.

### DETAILED DESCRIPTION

Techniques described herein relate to systems, devices and methods for protecting a surface from erosion.

A system for lining a substrate surface subjectable to erosion is described herein. The system includes a stud weldable tile having various characteristics enabling a more efficient installation process and an improved refractory performance and wear resistance over conventional systems. The stud weldable tile includes an erosion resistant plate and a stud. In some implementations, the stud weldable tile can further include a breakaway pin. In some implementations, the erosion resistant plate can be made of a metal alloy having desirable erosion resistant properties, such as a cobalt alloy. The stud of the stud weldable tile can enable a direct installation of the stud weldable tile onto the substrate surface via stud welding, such that the installation of the stud weldable tile can be performed in a single step rather than successively having to first weld an anchoring assembly to a surface and then applying a refractory material onto the anchoring assembly having to be cured in situ. Once the stud welding of the stud weldable tile as described herein onto the substrate is completed, the breakaway pin, if present, of the stud weldable tile can simply be removed from the stud weldable tile by applying a sufficient force thereon.

The system can further include a compressible membrane provided underneath the erosion resistant plate, partially surrounding the stud. The compressible membrane can be substantially non-porous and be configured to fill the space between the substrate surface and the stud weldable tile once the stud weldable tile is stud welded onto the substrate surface, thereby contributing to reducing hydrocarbon vapour and coke ingress underneath the erosion resistant plate. The compressible membrane is compressible so as to deform when the stud weldable tile is subjected to a colder temperature, such as during downtime, thus accommodating coke jacking or coke buildup and avoiding and subsequently putting stress on the remainder of the components of the stud weldable tile.

Various implementations of the erosion resistant plate and the stud are described herein. For instance, in some implementations, the erosion resistant plate and the stud can form a monolithic structure. In other implementations, the erosion resistant plate and the stud can be mechanically engaged with each other. In such implementations, the erosion resistant plate and the stud can either be made of the same material, or can be made from two distinct materials.

Alternatively, the stud weldable tile can include an anchor assembly comprising a stud and a plurality of anchor arms extending outwardly from the stud, and an erosion resistant plate can be molded around the plurality of anchor arms. A compressible membrane as briefly described above can also be engaged with the stud weldable tile. When the stud weldable tile includes an anchor assembly, a plurality of anchor arms and an erosion resistant plate that is molded around the plurality of anchor arms, the installation of the stud weldable tile can also be performed in a single step rather than successively having to first weld an anchoring assembly and then applying a refractory material onto the anchoring assembly and letting the refractory material cure in situ. Again, once the stud welding of the stud weldable tile is completed, the breakaway pin, if present, can simply be removed from the anchor assembly by applying a sufficient force thereon.

The method for lining a substrate surface subjectable to erosion with the stud weldable tile as described herein can be performed by welding the stud weldable tile onto the substrate surface, which can be done for instance by operatively engaging a stud welding gun with a breakaway pin of the stud weldable tile. The system described herein can be installed to create a new erosion resistant lining on a substrate surface, which can be for instance an internal wall of a reactor, a burner, a furnace, a cyclone, a coker, a horn chamber, a pipe, etc. Moreover, the system described herein can be used to repair a given zone of a substrate surface that has been subjected to damage, by installing the desired number of stud weldable tiles to cover this given zone.

Various implementations and features of the system for lining a substrate surface subjectable to erosion will now be described in greater detail in the following paragraphs.

### General Description of the System for Lining a Substrate Surface Subjectable to Erosion

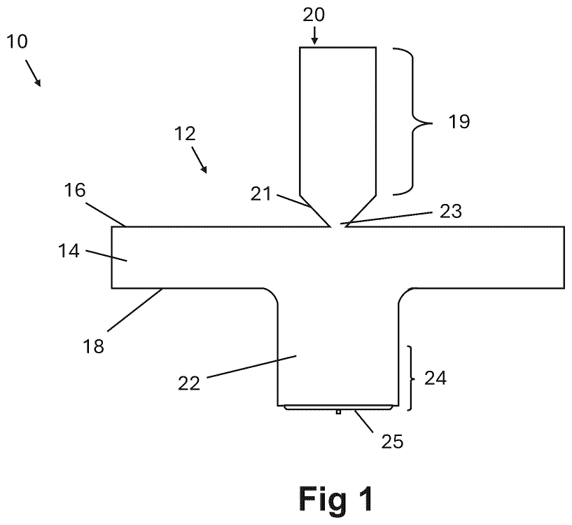

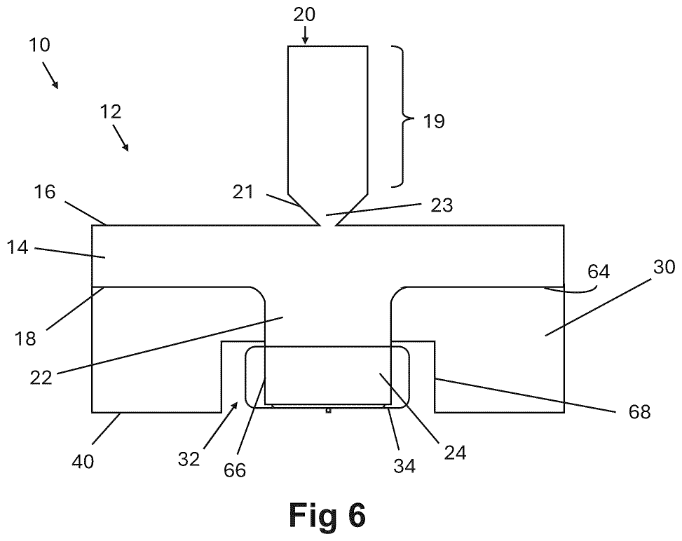

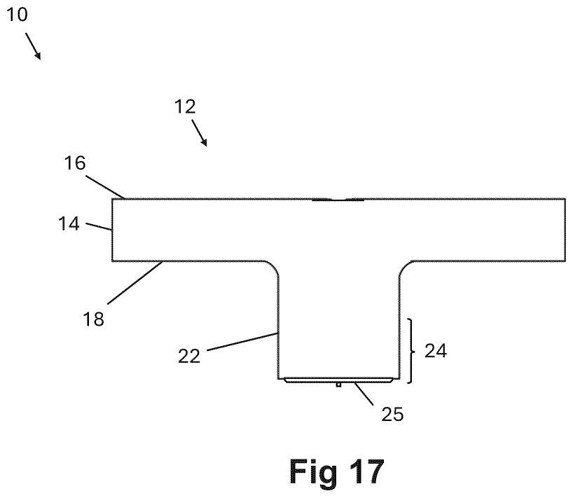

With reference to FIGS. 1 to 8 and 14, a system 10 for lining a substrate surface 50 subjectable to erosion is shown. In the implementations shown, the system 10 includes a stud weldable tile 12 having an erosion resistant plate 14, a breakaway pin 20 and a stud 22. It is to be understood that although a breakaway pin 20 is shown in FIGS. 1 to 8 and 14, in other implementations, the breakaway pin 20 can be omitted. For instance, FIG. 17 illustrates an implementation of a stud weldable tile 12 having an erosion resistant plate 14 and a stud 22, without a breakaway pin. In some implementations, the system 10 can further include a compressible membrane 30 engaged with the erosion resistant plate 14, as shown for instance in FIGS. 6 to 8. Additional details regarding each of these components are provided below.

### Erosion Resistant Plate

The erosion resistant plate 14 of the stud weldable tile 12 is configured to provide high-temperature resistance and to protect the structure from thermal shock, wear and erosion once the stud weldable tile 12 is welded onto the substrate surface 50.

The erosion resistant plate 14 includes a top surface 16 and a bottom surface 18, and has an erosion resistant plate thickness defined between the top surface 16 and the bottom surface 18. In some implementations, the erosion resistant plate thickness can range between about 5 mm and about 10 mm. It is to be understood that these dimensions are provided for exemplary purposes only, and that other erosion resistant plate thicknesses can also be suitable depending on the material from which the erosion resistant plate 14 is made and the intended application.

In some implementations, the erosion resistant plate 14 can be made from an erosion resistant plate material having properties enabling the erosion resistant plate 14 to sustain a various range of conditions. In some implementations, the erosion resistant plate material is a wear-resistant material that retains its wear-resistant properties, for instance at high temperatures. In some implementations, the erosion resistant plate material also has excellent resistance to many forms of mechanical and chemical degradation over a wide temperature range, and also retains a reasonable level of hardness up to 680° C. (1256° F.). In some implementations, the erosion resistant plate material further has good resistance to impact and cavitation erosion. In some implementations, the erosion resistant plate material includes a metal alloy, such as stainless steel, carbon steel, or cobalt-based alloys. In some implementations, the erosion resistant plate material can include a metal alloy having a hard carbide phase dispersed in a CoCr alloy matrix. Examples of cobalt-based alloys can include for instance Stellite® cobalt-based alloys, such as Stellite® 6 alloy.

In some implementations, the erosion resistant plate material from which the erosion resistant plate 14 is made can be selected in accordance with its compatibility for stud welding onto the substrate surface 50, and more particularly, its compatibility for the material from which the substrate surface 50 is made of, while reducing potential undesirable issues with carbon migration associated with high temperature exposure. In other words, the erosion resistant plate material of the erosion resistant plate 14 can thus be chosen to be compatible with the material of the substrate surface 50. In such implementations, the erosion resistant plate 14 and the stud 22 can form a monolithic structure, for instance as shown in FIG. 1, such that the erosion resistant plate and the stud 22 are made from the same material. For example, the erosion resistant plate material and the stud material can be made of stainless steel or a cobalt-based alloy, and the substrate surface can be made of stainless steel or carbon steel.

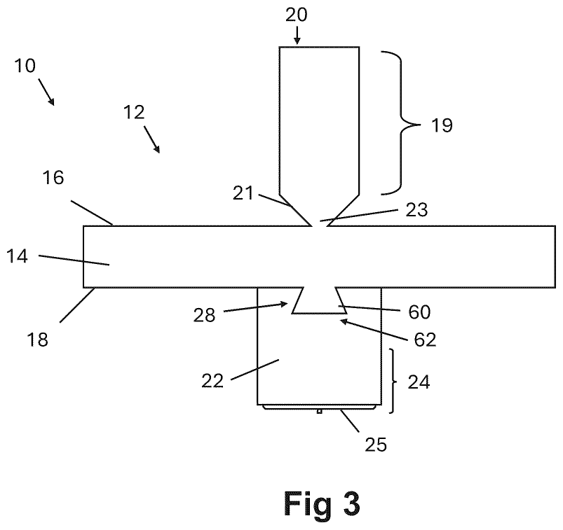

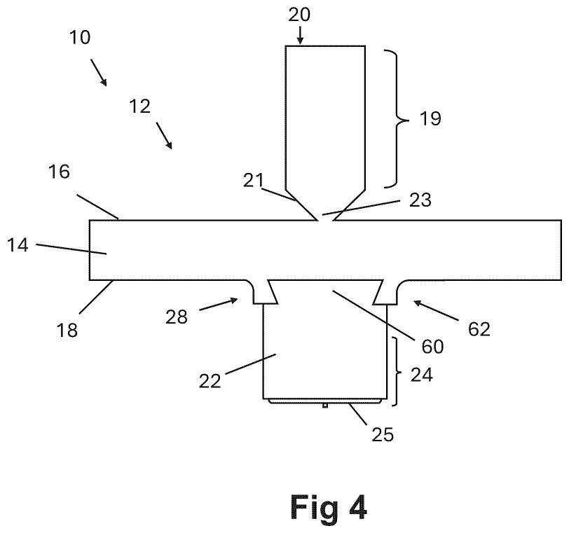

In alternative implementations and as shown in FIGS. 3 and 4, the erosion resistant plate 14 and the stud 22 can be mechanically engaged with each other and thus may not form a monolithic structure, offering the opportunity to select a given erosion resistant plate material for the erosion resistant plate 14, for instance in accordance with desired erosion resistant properties, while selecting a different material for the stud 22, i.e., a different stud material, for a desired welding performance with the material from which the substrate surface 50 is made of. Additional details regarding this aspect will be described in the paragraphs below related to the stud.

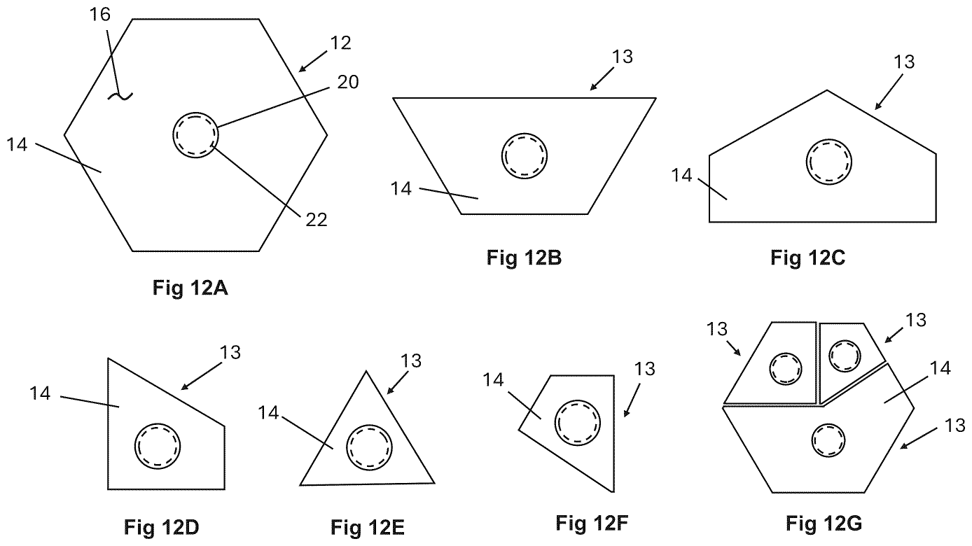

With reference to FIGS. 12A to 12G, the erosion resistant plate 14 of the stud weldable tile 12 can have various shapes. In some implementations, the erosion resistant plate 14 can be shaped as a polygon, such as a convex polygon. In some implementations, the shape of an adjacent erosion resistant plate 13 can be selected to be complementary to an erosion resistant plate 14, i.e., the shape of an adjacent erosion resistant plate 13 can represent a portion of the polygon of the erosion resistant plate 14, and can thus be referred to as a complementary polygon. Providing stud weldable tiles 12 with respective erosion resistant plates 14 having a polygon shape and a complementary polygon shape can enable multiple adjacent stud weldable tiles 12 to form a substantially continuous lining when applied onto the substrate surface 50 having a predetermined outer perimeter. In some implementations, the portion of the polygon of the erosion resistant plate 14 can form a convex polygon or a concave polygon. For instance, in the example shown in FIG. 12A, the erosion resistant plate 14 is shaped as a hexagon. In FIG. 12B to 12F, examples of complementary polygons of the erosion resistant plate 14 are shown, with a number of sides ranging from three to five. These alternative shapes are complementary to the shape of the erosion resistant plate 14 of FIG. 12A. FIG. 12G shows an example of three stud weldable tiles 12 that have complementary polygonal shapes, that when placed adjacent to each other, form a hexagon as the resulting the shape of the erosion resistant plate 14 of FIG. 12A.

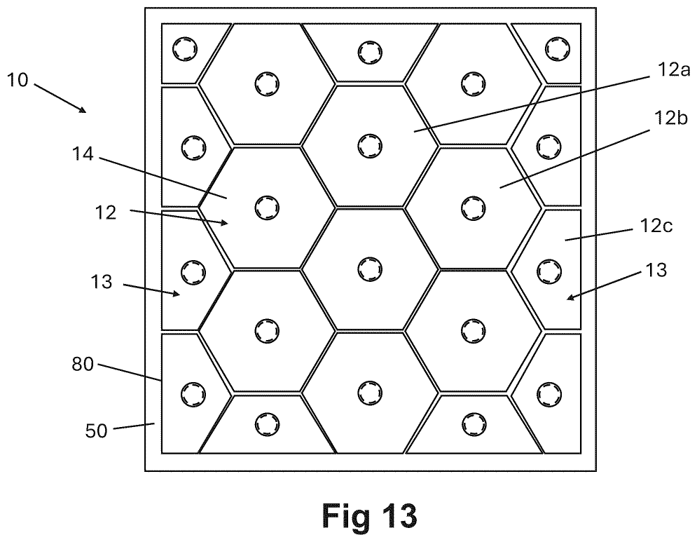

In accordance with the information presented above and with reference to FIG. 13, when a stud weldable tile 12 is approaching the outer perimeter 80 of the substrate surface 50, and thus when a full size erosion resistant plate 14 would not fit between the outer perimeter 80 of the substrate surface 50 and the closest stud weldable tile 12, an additional stud weldable tile 13 intended to be installed between the outer perimeter 80 of the substrate surface 50 and the full size erosion resistant plate 14 can have an outer perimeter shape corresponding to a portion of the polygon of the full size erosion resistant plate 14, i.e., an outer perimeter shape corresponding to a complementary polygon. The stud weldable tile identified by reference number “12c” also represents an adjacent or additional stud weldable tile 13, the installation of which onto a substrate surface is detailed hereinbelow when describing a method for lining a substrate surface subjectable to erosion or a method for repairing a lining previously installed on a substrate surface.

FIG. 13 thus illustrates an example where nine full size stud weldable tiles 12 are provided adjacent to each other, and eleven additional stud weldable tiles 13 having an outer perimeter shape corresponding to a complementary polygon relative to the full size erosion resistant plate 14. The plurality of potential shapes of the stud weldable tile 12 can offer flexibility regarding the location and the configuration of the substrate surface 50 where the system 10 can be installed. It is to be noted that the shapes based on the hexagon as illustrated in FIGS. 12A to 12G and 13 are for exemplary purposes only, and the same principles can be applied to erosion resistant plate 14 being shaped according to any polygon and any complementary polygon.

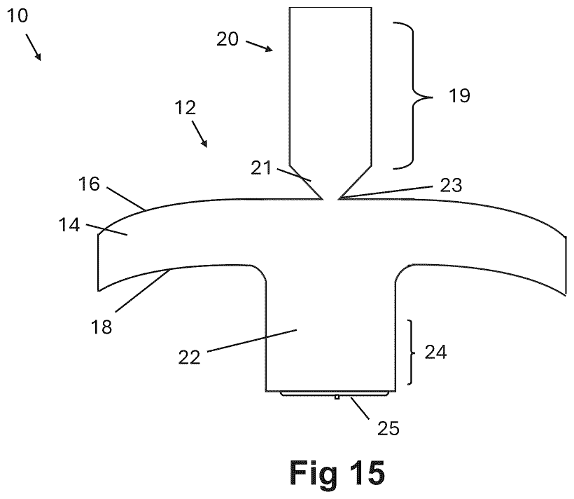

With reference to FIG. 15, in some implementations, the erosion resistant plate 14 of the stud weldable tile 12 can be curved, either toward the stud 22 or away from the stud 22. In the example shown in FIG. 15, the erosion resistant plate 14 of the stud weldable tile 12 is shown curved toward the stud 22. The curvature of the erosion resistant plate 14 can be selected so as to substantially conform to the curvature of the substrate surface 50 onto which the stud weldable tile 12 is intended to be placed against. For instance, for the erosion resistant plate 14 of the stud weldable tile 12 that is shown curved toward the stud 22, the stud weldable tile 12 can be configured to be applied against an outer surface of a pipe, the curvature of the erosion resistant plate 14 ensuring a suitable shape complementarity relative to the outer surface of the pipe.

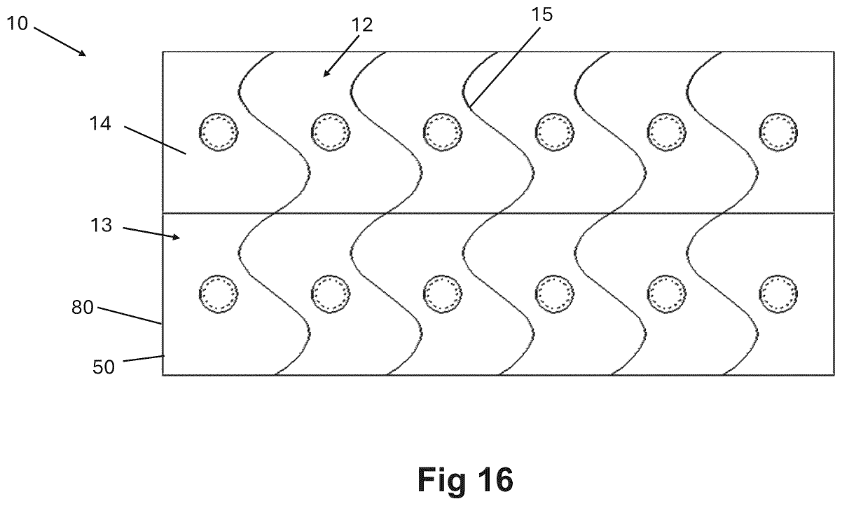

With reference to FIG. 16, in some implementations, the erosion resistant plate 14 of the stud weldable tile 12 can include one or more curved edges 15. In some implementations and as mentioned above, the shape of an erosion resistant plate 14 of an adjacent stud weldable tile 13 can be selected to be complementary to the erosion resistant plate 14 having curved edges 15, i.e., the shape of the erosion resistant plate 14 of the adjacent stud weldable tile 13 can also include a curved edge that is complementary to the curved edge of the erosion resistant plate 14. This complementary configuration of the erosion resistant plates 14 of the stud weldable tile 12 and the adjacent stud weldable tile 13 can enable multiple adjacent stud weldable tiles 12, 13 to form a substantially continuous lining when applied onto the substrate surface 50 having a predetermined outer perimeter.

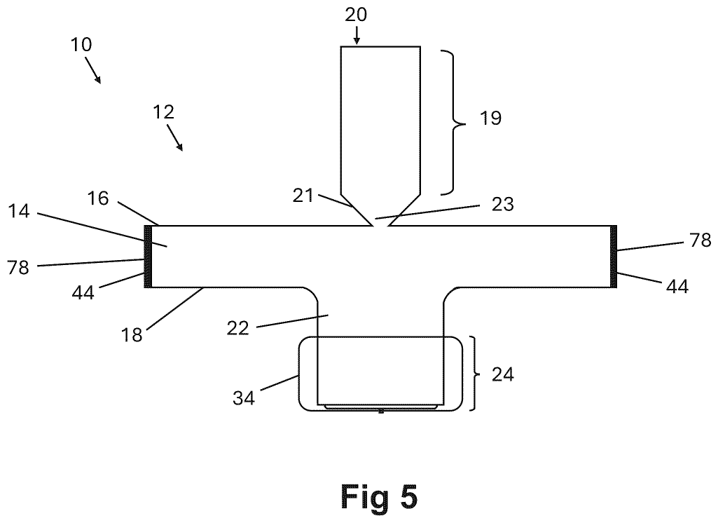

In some implementations and as shown in FIG. 5, the erosion resistant plate 14 can further include an electrically insulating coating 44 provided on a transversal surface 78 of the erosion resistant plate 14 to act as a barrier for electric currents between adjacent stud weldable tiles 12. The electrically insulating coating 44 can be made of a non-conducting material that can prevent an electric current from passing from one stud weldable tile to an adjacent stud weldable tile via the transversal surface 78 of the erosion resistant plate 14, and can instead contribute to directing the electric current towards a welding end 24 of the stud 22. In some implementations, the electrically insulating coating 44 can be made for instance of an electrically insulating material such as polyvinyl chloride, or a cellulosic material such as paper. In some implementations, the electrically insulating coating 44 can have a thickness that is less than 1 cm, or less than 0.08 cm.

### Breakaway Pin

In some implementations, the stud weldable tile 12 can further include a breakaway pin 20. A breakaway pin 20 is exemplified in FIGS. 1 to 8 and 14. In the implementations shown in FIGS. 1 to 8 and 14, the breakaway pin 20 extends outwardly from the top surface 16 of the erosion resistant plate 14, i.e., in an upward direction, and is configured to be operatively engageable with a stud welding gun. The breakaway pin 20 can form a monolithic structure with the erosion resistant plate 14. In alternative implementations, the breakaway pin 20 can be mechanically engaged with the erosion resistant plate 14.

In some implementations, when the breakaway pin 20 and the erosion resistant plate 14 form a monolithic structure, the breakaway pin 20 and the erosion resistant plate 14 can be made of the same material. In other implementations, when the breakaway pin 20 and the erosion resistant plate 14 are mechanically engaged with each other and thus may not form a monolithic structure, the erosion resistant plate 14 can be made of an erosion resistant plate material selected for instance in accordance with desired erosion resistant properties, while selecting a different material for the breakaway pin 20, i.e., a different breakaway pin material.

The breakaway pin 20 is configured to be detached from the erosion resistant plate 14 after stud welding the stud weldable tile 12 onto a substrate surface. In order to do so, the breakaway pin can include various features to facilitate its removal from the stud weldable tile 12. For instance, in some implementations, the breakaway pin 20 can include a contact portion 23 extending upwardly from the top surface 16 of the erosion resistant plate 14 and a breakaway portion 19 extending upwardly from the contact portion 23, the contact portion 23 being configured to be detached from the stud weldable tile 12 when subjected to a sufficient force to break away the breakaway pin 20 from the erosion resistant plate 14, i.e., so that the contact portion 23 can detach from the top surface 16 of the erosion resistant plate 14 and thus so that the entire breakaway pin 20 can be detached from the erosion resistant plate 14.

In some implementations, the contact portion 23 of the breakaway pin 20 can include a smaller width, or a smaller diameter when the breakaway pin 20 is substantially cylindrical, compared to the breakaway portion 19 of the breakaway pin 20. In the implementations shown in FIGS. 1 to 8 and 14, this smaller dimension of the contact portion 23 compared to the breakaway portion 19 is exemplified as a neck 21. In some implementations and as mentioned above, the breakaway pin 20 can be shaped as a substantially cylindrical prism, or as any other suitable shapes, such as a polygonal prism, an inverted pyramid or a truncated inverted pyramid, for instance. When the breakaway pin 20 is an inverted pyramid or a truncated inverted pyramid, the contact portion 23 can be obtained by the tip, or truncated tip, of the pyramid.

In some implementations, the breakaway pin 20 can have a breakaway pin height determined to be sufficiently high to enable operative engagement with a stud welding gun, while being short enough to reduce the amount of material needed and facilitate detachment from the erosion resistant plate 14. For instance, in some implementations, the breakaway pin 20 can have a breakaway pin height ranging from about 1 cm to about 3 cm.

Similarly, the width of the contact portion 23 and the width of the breakaway portion 19 can be chosen to be sufficiently small to reduce material consumption while enabling operative engagement of the stud welding gun with the breakaway pin 20. In some implementations, the width of the contact portion 23 can range between about 1 mm to about 8 mm, at the smallest location of the contact portion 23. In some implementations, the width of the breakaway portion 19 can range between about 5 mm to about 20 mm, at the largest location of the breakaway portion 19. For instance, in some implementations and as illustrated in FIGS. 1 to 8, the width of the contact portion 23 can be between about 2 mm and about 4 mm, at the smallest location of the contact portion 23, and the width of the breakaway portion 19 can range between about 8 mm about 12 mm, at the largest location of the breakaway portion 19. Of course, these dimensions are given for illustrative purposes only.

In the implementation shown in FIGS. 1 to 8, the breakaway pin 20 is located in a central region of the erosion resistant plate 14 and is substantially aligned with the stud 22 to enable the operative engagement of the stud welding gun with the stud 22. Other configurations are also possible.

In other implementations, when the breakaway pin 20 is omitted (such as shown in FIG. 17), the stud weldable tile 12 can be configured to be welded on a substrate substance according to any technique known in the art. For instance, in some implementations, the stud weldable tile 12 can be configured to be operatively engageable with a stud welding gun using a magnetic holder, which can provide a quick and reliable positioning of the stud weldable tile 12 without having to rely on a mechanical coupling. Alternatively, the outer perimeter of the stud weldable tile 12 can be partially gripped by a holder to maintain the stud weldable tile 12 in position for stud welding.

### Stud

The stud 22 of the stud weldable tile 12 extends outwardly from the bottom surface 18 of the erosion resistant plate 14 in a direction opposite to the breakaway pin 20 if a breakaway pin is present, i.e., in a downward direction. The stud 22 includes a welding end 24 that is configured to be stud welded to the substrate surface 50. The welding end 24 includes a welding end engaging surface 25 at an extremity thereof.

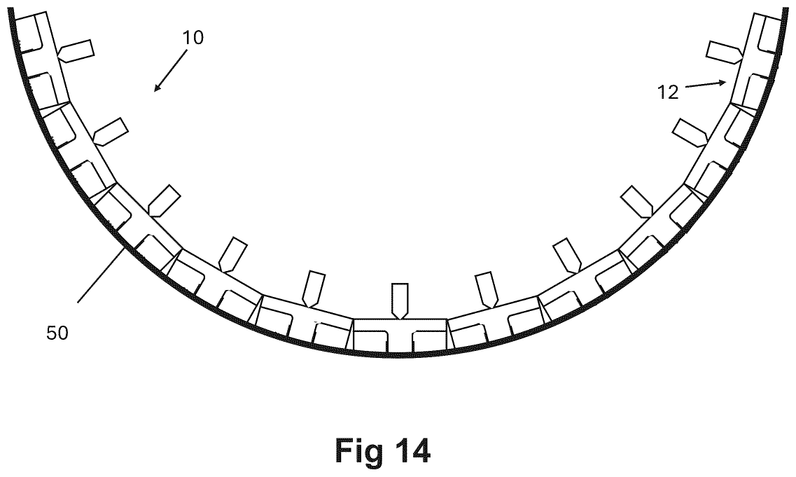

The substrate surface 50 can be any surface for which a protection against erosion is desired. The substrate surface 50 can thus be any surface subjectable to erosion. In addition, the substrate surface 50 can be a surface onto which a refractory lining is intended to be applied, to protect the surface and the structure including the surface from high temperatures. Examples of substrate surfaces for which both protection against erosion and application of a refractory lining are desired can include for instance an internal surface of a reactor, a burner, a furnace, a cyclone, a coker, a horn chamber, a pipe, etc. FIG. 14 illustrates an example where the substrate surface 50 corresponds to an internal surface of a vessel, exemplified as a cyclone. The substrate surface can thus be located in an enclosed environment that can be difficult to access during repairs. It is to be understood that the above examples of substrate surfaces are given for exemplary purposes only, and that the substrate surface 50 can be any surface subjectable erosion, located either internally or externally.

In some implementations, the stud material can be selected in accordance with its compatibility for welding to the substrate surface 50. As mentioned above regarding the erosion resistant plate 14, the stud material and the erosion resistant plate material can be the same, or the erosion resistant plate material and the stud material can be different. The stud material can be selected for instance according to a desired stud welding performance with respect to the material from which the substrate surface is made of, while reducing potential undesirable issues with carbon migration associated with high temperature exposure. In some implementations, the stud material can be for instance stainless steel, carbon steel, or any other material enabling the stud 22 to be welded to the substrate surface 50, including any suitable metallic alloy.

In some implementations, the erosion resistant plate material and the substrate surface 50 can be compatible to be stud welded to each other, and if it is desired that the erosion resistant plate 14 and the stud 22 form a monolithic structure, the erosion resistant plate material and the stud material can be the same. For instance, in some implementations, the erosion resistant plate 14 and the substrate surface 50 can be made of a cobalt alloy, and if the erosion resistant plate 14 and the stud 22 form a monolithic structure, the stud material can thus be the same as the erosion resistant plate material, i.e., a cobalt alloy. Alternatively, the erosion resistant plate 14 and the stud 22 may not form a monolithic structure and may rather be mechanically engaged with each other for various reasons, and the erosion resistant plate material and the stud material may nonetheless be selected to be the same, or be selected to be different.

The configuration of the erosion resistant plate 14 and the stud 22 can thus enable the respective selection of an erosion resistant plate material and a stud material according to their desired respective properties, which may or may not result in the erosion resistant plate material and the stud material being the same. The erosion resistant plate material can be selected for its properties with respect to erosion resistance, while the stud material can be selected for its stud welding properties, for instance.

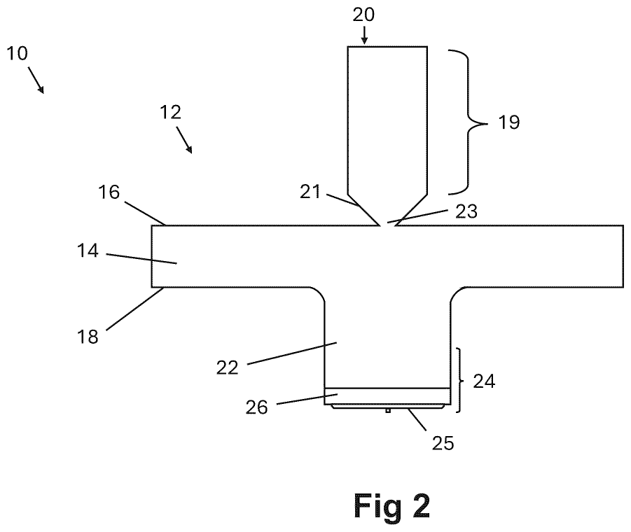

In some implementations, when the erosion resistant plate 14 and the stud 22 together form a monolithic structure but it is desired to provide enhanced welding properties to the stud 22, the welding end 24 of the stud 22 can include a buttered overlay 26. The buttered overlay 26 can be made of a buttered overlay material that is different from the erosion resistant plate material and the stud material when the erosion resistant plate 14 and the stud 22 form a monolithic structure, or from the stud material when the stud 22 is mechanically engaged with the erosion resistant plate 14. FIG. 2 illustrates an example of such a configuration of the stud 22, where the welding end 24 of the stud 22 is covered by a buttered overlay 26. The presence of the buttered overlay 26 can be useful for instance when the stud material 22 and the material from which the substrate surface 50 is made are different, for instance when carbon steel is intended to be stud welded to stainless steel. In such implementations, the buttered overlay material can be made of stainless steel, such that a layer of stainless steel, i.e., the same material (or at least a similar material) as the material from which the substrate surface is made, can be applied onto the surface of the welding end 24 for welding to the substrate surface to produce a stainless steel to stainless steel welded joint. It is to be understood that the examples of buttered overlay material and substrate surface material mentioned above are for illustrative purposes only, and that the principles described are applicable to other combinations of buttered overlay material and substrate surface material as known in the art. Additional examples of buttered overlay material can include carbon steel, nickel-based alloys, chromium-based alloys, or any metal alloy selected for its properties during and after welding to the substrate surface 50, thereby avoiding potential issues with carbon migration between the buttered overlay 26, the stud 22 and the substrate surface 50.

With reference to FIGS. 3 and 4, examples of a mechanical engagement between the erosion resistant plate 14 and the stud 22 are shown. In some implementations, the mechanical engagement between the erosion resistant plate 14 and the stud 22 can be achieved via an engagement member 28. In the implementation shown in FIG. 3, the engagement member 28 protrudes outwardly from the bottom surface 18 of the erosion resistant plate 14 and is shaped as a truncated pyramid. The engagement member 28 can thus be referred to as a male member 60 protruding outwardly from the bottom surface 18 of the erosion resistant plate 14, the male member 60 being configured for mechanical engagement with a corresponding female member 62 defined by the stud 22. In this exemplary implementation, the female member 62 and the male member 60 together define a dovetail. The mechanical engagement between the male member 60 and the female member 62 thereby mechanically connects the erosion resistant plate 14 and the stud 22 together. In the implementation shown in FIG. 4, the configuration of the engagement member 28 is different than the one shown in FIG. 3, and can be considered a reversed configuration when compared to the implementation shown in FIG. 3. In the implementation shown in FIG. 4, the engagement member 28 protrudes outwardly from the bottom surface 18 of the erosion resistant plate 14 and defines a female member 62. In turn, the stud 22 includes a tail, corresponding to a male member 60 configured for mechanical engagement with the corresponding female member 62. In this implementation, the female member 62 and the male member 60 also together define a dovetail. The mechanical engagement between the male member and the female member thereby mechanically connects the erosion resistant plate 14 and the stud 22 together. It is to be understood that other types of mechanical engagement between the erosion resistant plate 14 and the stud 22, and thus configurations of the engagement member 28, are also possible, as known in the art. Additional examples can include rivets, screws, bolts, inserts, or any combination thereof. It is to be understood that the above examples are described for illustrative purposes only, and that the erosion resistant plate 14 can be mechanically engaged with the stud 22 via any suitable mechanical attachment.

### Compressible Membrane

In some implementations and as shown in FIGS. 6 to 8, the system 10 can further include a compressible membrane 30 provided underneath the erosion resistant plate 14 and partially surrounding the stud 22. The compressible membrane 30 is configured to at least partially fill a void defined between the bottom surface 18 of the erosion resistant plate 14 and the substrate surface 50 once the stud weldable tile 12 is stud welded to the substrate surface 50. The compressible membrane 30 includes a substrate surface engaging portion 40 that is configured for placement against the substrate surface 50, and an erosion resistant plate engaging surface 64, opposite the substrate surface engaging portion 40, configured for placement in proximity of the bottom surface 18 of the erosion resistant plate 14. In some implementations, the erosion resistant plate engaging surface 64 of the compressible membrane 30 can be configured to be in direct contact with the bottom surface 18 of the erosion resistant plate 14, as exemplified in FIGS. 6 to 8.

The compressible membrane 30 can be made of a compressible membrane material configured to provide selected characteristics to enable achieving its purpose. For instance, in some implementations, the compressible membrane 30 can be configured to limit hydrocarbon vapours ingress that may otherwise occur when no compressible membrane 30 is present to fill the void defined between the bottom surface 18 of the erosion resistant plate 14 and the substrate surface 50 once the stud weldable tile 12 is welded to the substrate surface 50. If such hydrocarbon vapours ingress occurs during high operating temperatures, stress constraints on the components of the stud weldable tile 12 may or may not occur, or may occur within certain acceptable limits, as the stud 22 may expand upwardly. However, when a reduction in temperature subsequently occurs, for instance during turnarounds, and components of the stud weldable tile 12 such as the stud 22 contracts in a downward direction, if there is coke that has formed underneath the bottom surface 18 of the erosion resistant plate 14, the presence of the coke will prevent the stud 22 from contracting and undesired mechanical stress will be put on the components of the erosion resistant plate 12. In order to mitigate this challenge, the compressible membrane 30 is placed underneath the erosion resistant plate 14 to reduce hydrocarbon vapours ingress into the void defined between the bottom surface 18 of the erosion resistant plate 14 and the substrate surface 50 once the stud weldable tile 12 is stud welded to the substrate surface 50. The compressible membrane material can thus be selected to be a substantially non-porous material that prevents or reduces hydrocarbon vapours ingress given its substantially non-porous nature, while being sufficiently compressible to sustain variations in height of the void defined between the bottom surface 18 of the erosion resistant plate 14 and the substrate surface 50 that can occur in accordance with temperature variations once the stud weldable tile 12 is stud welded to the substrate surface 50.

In some implementations, the compressible membrane material can be configured to have a compressive strength between about 10 psi and about 100 psi at about 5% deformation. In some implementations, the compressible membrane material can be configured to have a density ranging from about 175 kg/m³ to about 450 kg/m³. In some implementations, the compressible membrane material can be a ceramic fiberboard material. Examples of ceramic fiberboard materials can include kaolin-based refractory fiber, including high purity blends of alumina, silica and mulite such as Kaowool® HP and Fiberfrax®, Duraboard®, among others. In some implementations, the compressible membrane 30 is thus configured to be dense enough to prevent or reduce vapour and coke impregnation, compressible enough to give before damaging the stud weldable tile, and to withstand high temperatures.

In some implementations and as shown in FIG. 6, the compressible membrane 30 can be spaced apart from a longitudinal periphery 66 of the welding end 24 of the stud 22. In such implementations, the compressible membrane 30 defines a ferrule-receiving cavity 32 between an inner surface of the compressible membrane 30 and the longitudinal periphery 66 of the welding end 24 of the stud 22. The ferrule-receiving cavity 32 is sized and configured to enable engagement of a ferrule 34 with the welding end 24 of the stud 22 such that the ferrule 34 can surround the welding end 24 of the stud 22, as shown in FIG. 6. The ferrule 34 is configured to contain mounting residue, and to shield and protect the stud 22 during the welding process, such as a drawn arc stud welding process, a rapid arc welding (RAW) process, a precision welding process, a short cycle stud welding process and a capacitor discharge stud welding process, among others. When the compressible membrane 30 defines a ferrule-receiving cavity 32, the ferrule 34 and the stud weldable tile 12 can be provided as separate components, and the ferrule 34 can be placed within the ferrule-receiving cavity 32 at a given time prior to stud welding. In other implementations, the stud weldable tile 12 can be provided with the ferrule 34 already engaged with the stud 22, without requiring the installer of the stud weldable tile 12 to actively engage the ferrule 34 and the stud 22 together. The width of the ferrule-receiving cavity 32 can vary in accordance with the size of the ferrule chosen to be used in combination with the stud weldable tile 12.

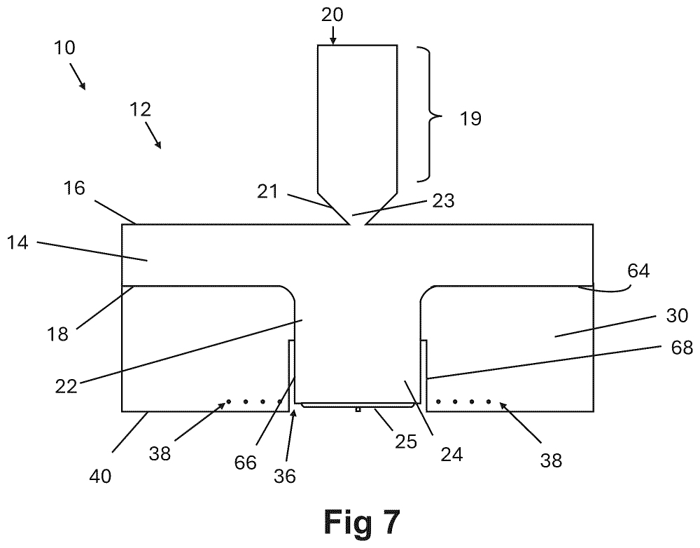

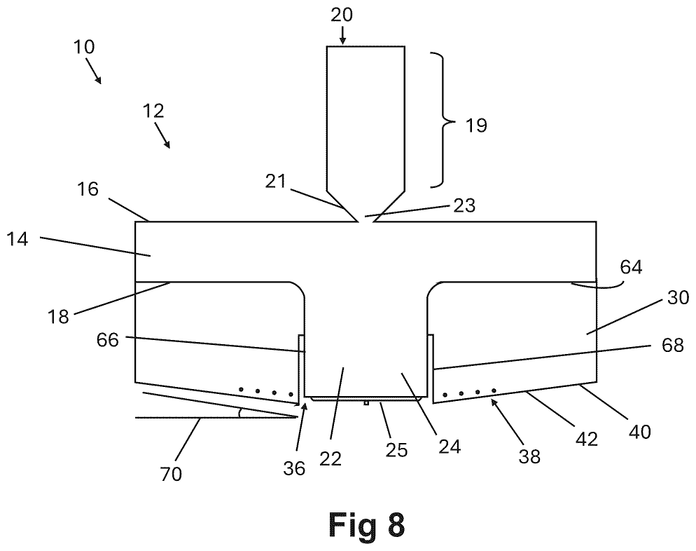

Alternatively, in some implementations, the compressible membrane 30 can be spaced apart from the longitudinal periphery 66 of the welding end 24 of the stud 22 to define a molten metal-receiving cavity 36. In such implementations, the compressible membrane 30 defines the molten metal-receiving cavity 36 between an inner surface 68 of the compressible membrane 30 and the longitudinal periphery 66 of the welding end 24 of the stud 22, the molten metal-receiving cavity 36 being sized and configured to receive molten metal generated from stud welding. In such implementations, and as shown in FIGS. 7 and 8, the compressible membrane 30 can include vents 38 that enable weld gas generated during welding to be vented out from the compressible membrane 30 when the stud weldable tile 12 is subject to stud welding. In such implementations, the compressible membrane 30 can thus be configured to act as a ferrule, such that providing a ferrule as a separate component of the stud weldable tile 12 can be avoided. The width of the molten metal-receiving cavity 36 can vary in accordance with the intended use of the stud weldable tile 12 to ensure proper performance of the compressible membrane 30 to act as a ferrule.

In some implementations and as shown in FIG. 8, the compressible membrane 30 can have a height that is taller in proximity of the stud 22 compared to the height of the compressible membrane 30 at its outer periphery, such that the substrate surface engaging portion 40 can be considered to correspond to an angled substrate surface engaging portion 42 (which can also be referred to as a tapered substrate surface engaging portion) having a compressible membrane angle 70. In some implementations, the angled substrate surface engaging portion 42 can be configured to follow a curvature of the substrate surface 50. FIG. 14 illustrates an example implementation in which the substrate surface engaging portion 40 of the compressible membrane 30 corresponds to an angled substrate surface engaging portion 42, with the angled substrate surface engaging portion 42 following the curvature of the substrate surface 50. The compressible membrane angle 70 defined between the angled substrate surface engaging portion 42 and a straight surface can vary depending on the curvature of the substrate surface 50 onto which the stud weldable tile 12 is intended to be stud welded to. For instance, as a general rule of thumb, for a smaller radius of curvature, it can be expected that the compressible membrane angle 70 will likely be larger than for a larger radius of curvature. In some implementations, the compressible membrane angle 70 can range between about 1° and about 5°. In some implementations, the compressible membrane angle 70 can range between about 2° and about 4°. In some implementations, the compressible membrane angle 70 can be about 3°. The presence of the angled substrate surface engaging portion 42 can enable avoiding interference from the compressible membrane 30 when performing the stud welding of the stud weldable tile 12. In some implementations, the stud 22 can extend outwardly past the compressible membrane 30 to enable a portion of the stud 22 to melt during the stud welding process while avoiding interference by the compressible membrane 30, such that once the stud 22 is stud welded to the substrate surface 50, the substrate surface engaging portion 40 of the compressible membrane 30 can fit snugly against the substrate surface 50.

### Alternative Implementation of a Stud Weldable Tile

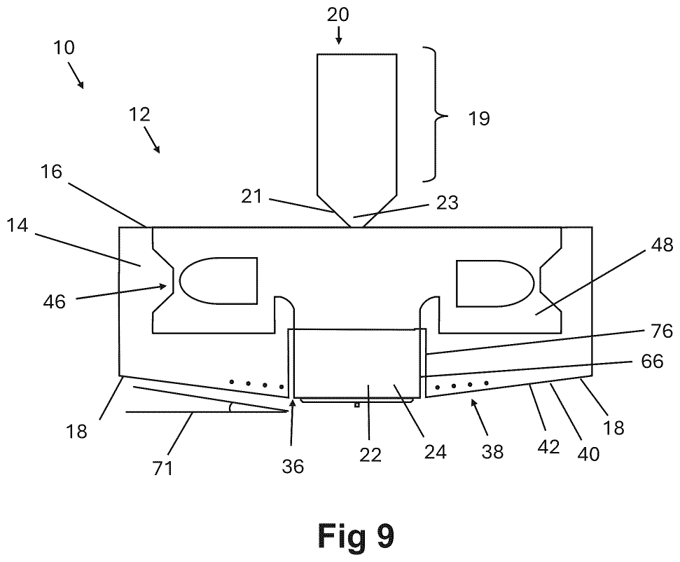

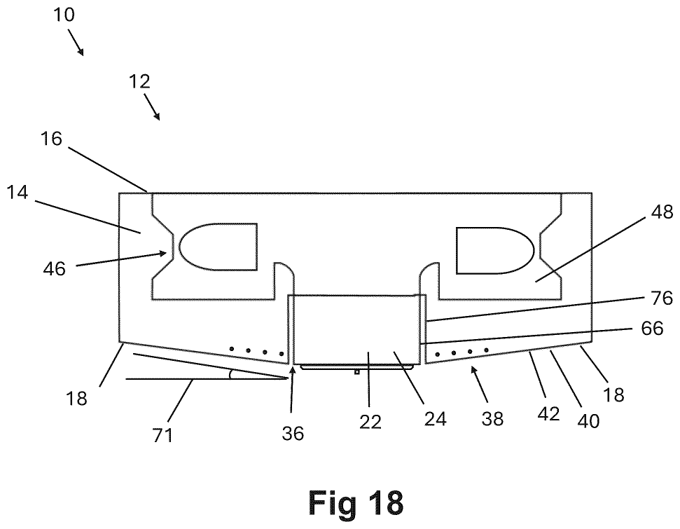

With reference to FIGS. 9 to 11, an alternative implementation of a system 10 for lining a substrate surface subjectable to erosion is shown, and will now be described in further detail. In the implementation shown, the system 10 includes a stud weldable tile 12 including an anchor assembly 46, an erosion resistant plate 14, and a breakaway pin 20. As mentioned above, although a breakaway pin 20 is shown in FIGS. 9 to 11, in other implementations, the breakaway pin 20 can be omitted. For instance, FIG. 18 illustrates an implementation of a stud weldable tile 12 including an anchor assembly 46 and an erosion resistant plate 14, without a breakaway pin.

The anchor assembly 46 includes a stud 22 having a welding end 24 configured to be stud welded onto a substrate surface, and a plurality of anchor arms 48 extending outwardly, i.e., in a radial direction, from the stud 22. In some implementations, the plurality of anchor arms 48 can extends outwardly from the stud 22 in a common plane. In some implementations, the anchor assembly 46 can include a single anchor arm 48 instead of a plurality of anchor arms 48. In some implementations, the plurality of anchor arms 48 and the stud 22 can be made of a single piece, i.e., the plurality of anchor arms 48 and the stud 22 can form a monolithic structure defining the anchor assembly 46. In other implementations, the plurality of anchor arms 48 and the stud 22 can be mechanically engaged with each other, thereby defining the anchor assembly 46 as a multi-piece structure.

The anchor assembly 46 is configured to enable pre-casting an erosion resistant plate 14 around the plurality of anchor arms 48 (or the anchor arm if only one is present). The anchor assembly 46 can take various shapes, as long as it is possible to precast the erosion resistant plate 14 around the plurality of anchor arms 48 (or the anchor arm if only one is present). For instance, in some implementations, the anchor assembly 46 can be configured similarly to a conventional tulip-shaped SpeedCell® or to a conventional SpeedHex® system. In contrast to these conventional systems, which required the subsequent application of a refractory material that needs to be cured in situ, the stud weldable tile 12 described herein is provided as a ready-to-use stud weldable tile 12 with the erosion resistant plate 14 already combined with the anchor assembly 46 in a precast form, such that no subsequent application of a refractory material that needs to be cured in situ is required. Additional details regarding the configuration of the erosion resistant plate 14 when combined with the anchor assembly 46 are provided below.

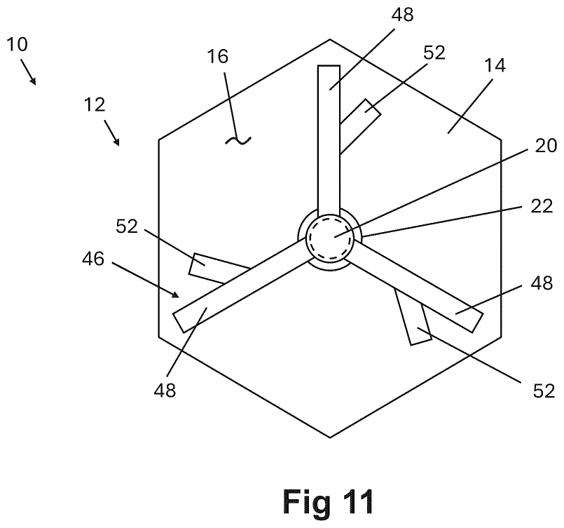

With reference more specifically to FIG. 11, in the example shown, the anchor assembly 46 includes three arms 48 provided at about 120° from each other. When the anchor assembly 46 includes two arms, the arms can be provided for instance at 180° from each other. It is to be understood that although the arms 48 can be provided at substantially the same angle from each other, the arms 48 can also be provided at different angles from each other, depending for instance on the overall shape of the erosion resistant plate 14.

In some implementations, at least one anchor arm of the plurality of anchor arms 48 can include a tab 52 that extends outwardly from the at least one anchor arm. The tab 52 can be configured to facilitate the precasting of the erosion resistant plate 14 around the arms 48 of the anchor assembly 46, thereby contributing to further anchor the erosion resistant plate 14 around the anchor assembly 46. The tab 52 can extend outwardly from a corresponding arm at any suitable angle that enables further anchoring the erosion resistant plate 14 around the anchor assembly 46. In some implementations, the angle at which the tab 52 extends from the corresponding arm 48 can range between about 20° to about 90°. In some implementations, the tab 52 can have a length that corresponds to between about a fifth and about a half of a length of the arm 48.

In some implementations, the anchor assembly 46 is made of an anchor assembly material that includes a metal alloy, such as stainless steel, carbon steel, or cobalt-based alloys. In some implementations, the anchor assembly material can include metal alloy having a hard carbide phase dispersed in a CoCr alloy matrix. Examples of cobalt-based alloys can include for instance Stellite® cobalt-based alloys, such as Stellite® 6 alloy. In some implementations, the anchor assembly material can be selected in accordance with its properties to act as a supporting feature for the erosion resistant plate 14.

In some implementations, when the plurality of anchor arms 48 and the stud 22 together form a monolithic structure, the plurality of anchor arms 48 and the stud 22 can thus be made of the same material, i.e., the anchor assembly material.

In some implementations, when the plurality of anchor arms 48 and the stud 22 are mechanically engaged with each other, the plurality of anchor arms 48 and the stud 22 can be made of the same material or from distinct materials. When the plurality of anchor arms 48 and the stud 22 are made from distinct materials, the material for the plurality of anchor arms 48 can be selected to provide support of the erosion resistant plate 14, and the material for the stud 22 can be selected to enable a suitable welding performance to the substrate surface 50.

As mentioned above, in some implementations, the plurality of anchor arms 48 and the stud 22 can be mechanically engaged with each other. Non-limiting examples of mechanical engagement between the plurality of anchor arms 48 and the stud 22 can include rivets, dovetails, screws, bolts, inserts, or any combination thereof.

In some implementations, the welding end 24 of the stud 22 can include a buttered overlay 26 as described above. The buttered overlay 26 can be made of a buttered overlay material that is different from the anchor assembly material when the plurality of anchor arms and the stud form a monolithic structure, or different from the stud material when the stud 22 is mechanically engaged with the anchor assembly 46.

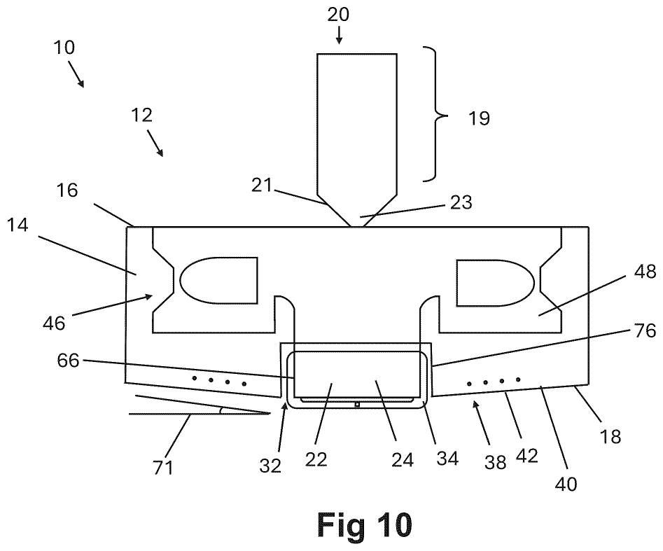

In some implementations, the stud weldable tile 12 can include a breakaway pin 20. In the implementation shown in FIGS. 9 and 10, the breakaway pin 20 extends outwardly from the anchor assembly 46, in an upward direction opposite to the stud 22, and is configured to be operatively engageable with a stud welding gun. In some implementations, the breakaway pin 20 can form a monolithic structure with the anchor assembly 46. In alternative implementations, the breakaway pin 20 can be mechanically engaged with the anchor assembly 46. Similarly to the description made above with respect to FIGS. 1 to 8, the breakaway pin 20 is configured to be detached from the anchor assembly 46 after welding of the stud weldable tile 12 to the substrate surface 50. In some implementations, the breakaway pin 20 and the anchor assembly 46 can be made of the same material, or from different materials. For instance, in some implementations, the anchor assembly material and the breakaway pin material can comprise a metal alloy, as described above.

In some implementations, the breakaway pin 20 and the plurality of anchor arms 48 can form a monolithic structure, and the stud 22 can be mechanically engaged with the plurality of anchor arms 48.

### Erosion Resistant Plate

The erosion resistant plate 14 of the stud weldable tile 12 is configured to provide high-temperature resistance and to protect the structure from thermal shock, wear and erosion once the stud weldable tile 12 is welded onto the substrate surface 50. The erosion resistant plate 14 includes a top surface 16 and a bottom surface 18 corresponding to a substrate surface engaging portion 40, and is precast around the plurality of anchor arms 48 of the anchor assembly 46.

The erosion resistant plate 14 is made from an erosion resistant plate material having properties enabling the erosion resistant plate 14 to sustain a various range of conditions. In some implementations, the erosion resistant plate material is a wear-resistant material that retains its properties even at high temperatures. In some implementations, the erosion resistant plate material also has excellent resistance to many forms of mechanical and chemical degradation over a wide temperature range, and retains a reasonable level of hardness up to 680° C. (1256° F.). In some implementations, the erosion resistant plate material further has good resistance to impact and cavitation erosion. In some implementations, the erosion resistant plate material includes a refractory material. For instance, in some implementations, the refractory material can be precast around the plurality of anchor arms 48 of the anchor assembly 46, and cured prior to engaging the stud weldable tile 12 to the substrate surface 50 via stud welding. In some implementations, the erosion resistant plate material can include a refractory ceramic, such as silica, alumina-silica, and basic refractories such as dolomite, magnesite, calcite, forsterite, zirconia, zircon, and spinel, etc.

In some implementations, the erosion resistant plate 14 can have an erosion resistant plate thickness defined between the top surface 16 and the bottom surface 18 ranging from about 5 mm to about 10 mm. It is to be understood that these dimensions are provided for exemplary purposes only, and that other erosion resistant plate thicknesses can also be suitable depending on the material from which the erosion resistant plate 14. In some implementations and as shown in FIGS. 9 and 10, the erosion resistant plate 14 can be precast to have an erosion resistant plate thickness enabling engagement of the bottom surface 18, i.e., the substrate surface engaging portion 40 of the erosion resistant plate 14, with the substrate surface 50 once the stud weldable tile is stud welded to the substrate surface 50. In such implementations, the engagement of the bottom surface 18 of the erosion resistant plate 14 with the substrate surface 50, for instance by directly contacting the bottom surface 18 of the erosion resistant plate 14 with the substrate surface 50, can contribute to reducing coke buildup between the erosion resistant plate 14 and the substrate surface 50.

With reference to FIGS. 9 and 10, in some implementations, the erosion resistant plate 14 can have an erosion resistant plate height that is taller in proximity of the stud 22 compared to the erosion resistant plate height of the erosion resistant plate 14 at an outer periphery thereof. In such implementations, the substrate surface engaging portion 40 of the erosion resistant plate 14 can be considered as corresponding to an angled substrate surface engaging portion 42 (which can also be referred to as a tapered substrate surface engaging portion) having an erosion resistant plate angle 71. In some implementations, the angled substrate surface engaging portion 42 can be configured to follow a curvature of the substrate surface 50. The erosion resistant plate angle 71 defined between the angled substrate surface engaging portion 42 and a straight surface can vary depending on the curvature of the substrate surface 50 onto which the stud weldable tile 12 is intended to be stud welded to. For instance, as a general rule of thumb, for a smaller radius of curvature, it can be expected that erosion resistant plate angle 71 will likely be larger than for a larger radius of curvature. In some implementations, the erosion resistant plate angle 71 can range between about 1° and about 5°. In some implementations, the erosion resistant plate angle 71 can range between about 2° and about 4°. In some implementations, the erosion resistant plate angle 71 can be about 3°. The presence of the angled substrate surface engaging portion 42 can enable avoiding interference from the erosion resistant plate 14 when performing the stud welding of the stud weldable tile 12. In some implementations, the stud 22 can extend outwardly past the erosion resistant plate 14 to enable a portion of the stud 22 to melt during the stud welding process while avoiding interference by the erosion resistant plate 14, such that once the stud 22 is stud welded to the substrate surface 50, the substrate surface engaging portion 40 of the erosion resistant plate 14 can fit snugly against the substrate surface 50.

With reference to FIG. 10, in some implementations, the erosion resistant plate 14 can be spaced apart from the longitudinal periphery 66 of the welding end 24 of the stud 22. In such implementations, the erosion resistant plate 14 defines a ferrule-receiving cavity 32 between an inner surface 76 of the erosion resistant plate 14 and the longitudinal periphery 66 of the welding end 24 of the stud 22. The ferrule-receiving cavity 32 is sized and configured to enable engagement of a ferrule 34 with the welding end 24 of the stud 22 such that the ferrule 34 can surround the welding end 24 of the stud 22. The ferrule 34 is configured to contain mounting residue, and to shield and protect the stud 22 during the welding process. When the erosion resistant plate 14 defines a ferrule-receiving cavity 32, the ferrule 34 and the stud weldable tile 12 can be provided as separate components, and the ferrule 34 can be placed within the ferrule-receiving cavity 32 at a given time prior to stud welding. In other implementations, the stud weldable tile 12 can be provided with the ferrule 34 already engaged with the stud 22, without requiring the installer of the stud weldable tile 12 to actively engage the ferrule 34 and the stud 22 together. The width of the ferrule-receiving cavity 32 can vary in accordance with the size of the ferrule 34 chosen to be used in combination with the stud weldable tile 12.

With reference to FIG. 9, in other implementations, the erosion resistant plate 14 can be spaced apart from the longitudinal periphery 66 of the welding end 24 of the stud 22 to define a molten metal-receiving cavity 36 between an inner surface 76 of the erosion resistant plate 14 and the longitudinal periphery 66 of the welding end 24 of the stud 22, the molten metal-receiving cavity 36 being sized and configured to receive molten metal formed during welding. In such implementations, the erosion resistant plate 14 can include vents 38 that enable weld gas generated during welding to be vented out from the erosion resistant plate 14 when the stud weldable tile 12 is subject to stud welding. In such implementations, the erosion resistant plate 14 can thus be further configured to act as a ferrule, such that providing a ferrule as a separate component of the stud weldable tile 12 can be avoided. The width of the molten metal-receiving cavity 36 can vary in accordance with the intended use of the stud weldable tile 12 to ensure proper performance of the erosion resistant plate 14 to as a ferrule.

In accordance with the description of the erosion resistant plate 14 made hereinabove, and as shown in FIGS. 12A to 12G and 13, the erosion resistant plate 14 of the stud weldable tile 12 shown in FIGS. 9 to 11 can have various shapes. In some implementations, the erosion resistant plate 14 can be shaped as a polygon. In some implementations, the erosion resistant plate 14 can be shaped as a complementary polygon. The plurality of potential shapes of the stud weldable tile 12 can offer flexibility regarding the location and the configuration of the substrate surface 50 where the system 10 can be installed. Thus, it is to be understood that the features described above with reference to FIGS. 12A to 12G and 13 are also applicable to FIGS. 9 to 11, and will not be described again for sake of completeness.

In accordance with the description made above with reference to the erosion resistant plate 14 shown in FIGS. 15 and 16, the erosion resistant plate 14 shown in FIGS. 9 and 10 can be curved toward the stud 22 or away from the stud 22, and/or can include one or more curved edges.

In some implementations, the erosion resistant plate 14 can further include an electrically insulating coating (not shown) provided on a transversal surface of the erosion resistant plate 14 to act as a barrier for electric currents between adjacent stud weldable tiles 12. The electrically insulating coating can be made of a non-conducting material that can prevent an electric current from passing from one stud weldable tile to an adjacent stud weldable tile via the transversal surface of the erosion resistant plate 14 and can instead contribute to directing the electric current towards a welding end 24 of the stud 22. In some implementations, the electrically insulating coating can be made for instance of an electrically insulating material such as polyvinyl chloride, or a cellulosic material such as paper.

### Method for Lining a Substrate Surface Subjectable to Erosion With a Stud Weldable Tile

A method for lining a substrate surface subjectable to erosion with a stud weldable tile as described herein will now be described in further detail.

The method includes stud welding a first stud weldable tile onto the substrate surface. In some implementations, when a breakaway pin is present, a stud welding gun can be operatively engaged with the stud weldable tile via the breakaway pin stud to weld the first stud weldable tile onto the substrate surface. The operative engagement of the stud weldable gun with the breakaway pin can enable electrical current to be transmitted and transferred to the welding end of the stud, in accordance with conventional techniques known in the art, so that welding can occur between the welding end of the stud and the substrate surface.

Alternatively, when the breakaway pin is omitted, the stud weldable tile can be welded onto the substrate substance according to any technique known in the art. For instance, in some implementations, a stud welding gun can be operatively engaged with the stud weldable tile while using a magnetic holder to position of the stud weldable tile, or while using a holder configured to grip a portion of the outer perimeter of the stud weldable tile.

The method can then include stud welding a second stud weldable tile onto the substrate surface. The stud welding of the second stud weldable tile onto the substrate surface can be performed by positioning the second stud weldable tile directly adjacent to the first stud weldable tile, or at another location depending on a predetermined stud weldable tile pattern. For instance, with reference to FIG. 13, the first weldable tile 12a can be stud welded at a given location on the substrate surface 50, and the second weldable tile 12b can be stud welded directly adjacent to the first weldable tile 12a.

When the second weldable tile 12b is stud welded to the substrate surface, if there is sufficient space remaining on the substrate surface, the shape of the second stud weldable tile 12b can be the same as the first weldable tile 12a, as shown in FIG. 13. For instance, in FIG. 13, the shape of the first stud weldable tile 12a is a hexagon, and the shape of the second weldable tile 12b is also a hexagon. In other implementations, the shape of the first and second stud weldable tiles 12a, 12b can be different from one another.

The method can further include stud welding at least one additional stud weldable tile onto the substrate surface until a selected surface area of the substrate surface is covered by multiple stud weldable tiles to form a substantially continuous lining. Similarly to what is described above regarding the second weldable tile, the stud welding of the at least one additional stud weldable tile onto the substrate surface can be performed by positioning respective ones of the at least one additional stud weldable tile directly adjacent to the first and second stud weldable tiles, or at another location depending on a predetermined stud weldable tile pattern. For instance, with reference to FIG. 13, the first and second weldable tiles 12a, 12b can be stud welded at given locations on the substrate surface, and a third weldable tile 12c can be stud welded directly adjacent to one of the first and second weldable tiles 12a, 12b, and so on.

When the third weldable tile 12c is stud welded to the substrate surface, if there is sufficient space on the substrate surface, the shape of the third stud weldable tile 12c can be the same as the first weldable tile 12a and/or the second weldable tile 12b, or if there is insufficient space on the substrate surface, the shape of the third stud weldable tile 12c can be different than the shape of the first weldable tile 12a and/or the second weldable tile 12b. For instance, in FIG. 13, the shape of the first and second stud weldable tiles 12a, 12b is a hexagon, and the shape of the third weldable tile 12c is shaped as a complementary polygon relative to the hexagon to enable placement of the third stud weldable tile 12c adjacent to the outer perimeter 80 of the substrate surface 50.

The method further includes detaching respective breakaway pins from the first stud weldable tile, the second stud weldable tile, and the at least one additional stud weldable tile, if indeed the stud welding was performed via respective breakaway pins. The detaching of the respective breakaway pins can be performed following the stud welding of a respective one of the multiple stud weldable tiles, or the detaching of the respective breakaway pins can be performed after all multiple stud weldable tiles are stud welded to the substrate surface.

A method for repairing a lining previously installed on a substrate surface of an equipment is also provided. Such lining may be damaged during normal operating procedures, therefore subsequently requiring repair to maintain a proper integrity of the equipment. The damaged lining can be removed or may already be completely stripped depending on the extent of the damage.

The method includes stud welding a first stud weldable tile as defined herein onto a portion of the substrate surface stripped of a previously installed erosion lining. The method can further include stud welding a second stud weldable tile as defined herein onto the portion of the substrate surface, and optionally stud welding at least one additional stud weldable tile as defined herein onto the portion of the substrate surface until the portion of the substrate surface is covered by multiple stud weldable tiles.

The shapes of the stud weldable tiles can be selected so that the multiple stud weldable tiles, once stud welded onto the portion of the substrate surface, form a substantially continuous lining with the previously installed lining. The multiple stud weldable tiles can thus be installed onto the portion of the substrate surface stripped of a previously installed erosion lining, adjacent to undamaged lining.

Similar considerations as described above regarding the shapes of the multiple stud weldable tiles are also applicable when the multiple stud weldable tiles are used to repair a lining previously installed on the substrate surface.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A system for lining a substrate surface subjectable to erosion, the system comprising:
a stud weldable tile, comprising:
an erosion resistant plate made of an erosion resistant plate material and having a top surface and a bottom surface opposite the top surface; and
a stud extending outwardly from the bottom surface of the erosion resistant plate, the stud being made of a stud material and having a welding end configured to be welded to the substrate surface.

2. The system of claim 1, wherein the erosion resistant plate and the stud form a monolithic structure.

3. The system of claim 1, wherein the erosion resistant plate is mechanically engaged with the stud.

4. The system of claim 1, wherein the erosion resistant plate material and the stud material are distinct materials.

5. The system of claim 1, wherein the stud material comprises carbon steel or stainless steel.

6. The system of claim 1, wherein the erosion resistant plate material comprises a metal alloy.

7. The system of claim 1, further comprising a compressible membrane provided underneath the erosion resistant plate and partially around the stud to at least partially fill a void defined between the bottom surface of the erosion resistant plate and the substrate surface once the stud weldable tile is welded to the substrate surface, the compressible membrane having a substrate surface engaging portion.

8. The system of claim 7, wherein the compressible membrane is spaced apart from the welding end of the stud, thereby defining a ferrule-receiving cavity configured to receive a ferrule therein.

9. The system of claim 8, further comprising the ferrule surrounding the welding end of the stud and received within the ferrule-receiving cavity to contain mounting residue from the stud welding when the stud weldable tile is subjected to welding.

10. The system of claim 7, wherein the compressible membrane is spaced apart from the welding end of the stud, thereby defining a molten metal-receiving cavity configured to receive molten metal therein.

11. The system of claim 10, wherein the compressible membrane defines vents enabling weld gas generated during welding to be vented out from the compressible membrane when the stud weldable tile is subjected to welding, the compressible membrane being non-porous and configured to act as a ferrule.

12. The system of claim 7, wherein the compressible membrane has a height that is taller in proximity of the stud compared to the height of the compressible membrane at an outer periphery thereof, such that the substrate surface engaging portion is an angled substrate surface engaging portion configured to follow a curvature of the substrate surface.

13. The system of claim 7, wherein the stud extends outwardly past the compressible membrane.

14. The system of claim 7, wherein the compressible membrane comprises a ceramic fiberboard material.

15. The system of claim 14, wherein the compressible membrane comprises kaolin-based refractory fibers.

16. The system of claim 1, further comprising a breakaway pin extending outwardly from the top surface of the erosion resistant plate in a direction opposite to the stud and being operatively engageable with a stud welding gun, the breakaway pin being configured to be detached from the erosion resistant plate after stud welding the stud weldable tile.

17. The system of claim 1, wherein the erosion resistant plate is curved away from the stud or toward the stud.

18. The system of claim 1, wherein the welding end of the stud comprises a buttered overlay.

19. The system of claim 1, wherein the erosion resistant plate is shaped as a polygon.

20. The system of claim 1, wherein an adjacent erosion resistant plate configured for placement adjacent to the stud weldable tile is shaped as a complementary polygon.

21. The system of claim 1, wherein the erosion resistant plate includes a curved edge.

22. The system of claim 1, wherein the erosion resistant plate comprises a coating provided on a transversal surface of the erosion resistant plate to act as a barrier of an electric current between adjacent stud weldable tiles.

23. A system for lining a substrate surface subjectable to erosion, the system comprising:
a stud weldable tile, comprising:
an anchor assembly made of an anchor assembly material, comprising:
a stud having a welding end configured to be welded to the substrate surface; and
a plurality of anchor arms extending outwardly from the stud in a common plane; and
an erosion resistant plate precast around the plurality of anchor arms, the erosion resistant plate being made of an erosion resistant plate material and having a top surface and a bottom surface opposite the top surface.

24. The system of claim 23, further comprising a breakaway pin extending outwardly from the anchor assembly opposite to the stud and being operatively engageable with a stud welding gun, the breakaway pin being configured to be detached from the anchor assembly after stud welding the stud weldable tile.

25. The system of claim 24, wherein the breakaway pin and the anchor assembly form a monolithic structure.

26. The system of claim 23, wherein the erosion resistant plate material comprises a refractory material.

27. The system of claim 26, wherein the refractory material comprises a ceramic.

28. The system of claim 23, wherein the anchor assembly material comprises a metal alloy.

29. The system of claim 23, wherein at least one anchor arm of the plurality of anchor arms comprises a tab extending outwardly from the at least one anchor arm to further anchor the erosion resistant plate.

30. The system of claim 23, wherein the plurality of anchor arms is mechanically engaged with the stud.

31. The system of claim 23, wherein the welding end of the stud comprises a buttered overlay.

32. The system of claim 23, wherein the erosion resistant plate at least partially fills a void defined between the plurality of anchor arms and the substrate surface once the stud weldable tile is welded to the substrate surface, the erosion resistant plate having a substrate surface engaging portion.

33. The system of claim 32, wherein the erosion resistant plate is spaced apart from the welding end of the stud, thereby defining a ferrule-receiving cavity configured to receive a ferrule therein.

34. The system of claim 33, further comprising the ferrule surrounding the welding end of the central stud and received within the ferrule-receiving cavity to contain mounting residue from the stud welding when the stud weldable tile is subjected to welding.

35. The system of claim 32, wherein the erosion resistant plate is spaced apart from the welding end of the stud, thereby defining a molten metal-receiving cavity configured to receive molten metal therein.

36. The system of claim 35, wherein the erosion resistant plate defines vents enabling weld gas generated during welding to be vented out from the erosion resistant plate when the stud weldable tile is subjected to welding, the erosion resistant plate being configured to act as a ferrule.

37. The system of claim 32, wherein the erosion resistant plate has a height that is taller in proximity of the stud compared to the height of the erosion resistant plate at an outer periphery thereof, such that the substrate surface engaging portion is an angled substrate surface engaging portion configured to follow a curvature of the substrate surface.

38. The system of claim 23, wherein the stud extends outwardly past the erosion resistant plate.

39. The system of claim 23, wherein the erosion resistant plate is shaped as a polygon.

40. The system of claim 23, wherein an adjacent erosion resistant plate configured for placement adjacent to the stud weldable tile is shaped as a complementary polygon.

41. The system of claim 23, wherein the erosion resistant plate comprises a coating provided on a transversal surface of the erosion resistant plate to act as a barrier of an electric current between adjacent stud weldable tiles.
